(19) United States
(12) Patent Application Publication
(10) Pub. No.: US 2025/0044845 A1
(43) Pub. Date: Feb. 6, 2025

(54) PREDICTIVE POWER STEERING IN SOCS

(71) Applicant: Samsung Electronics Co., Ltd., Suwon-si (KR)

(72) Inventors: Praveen FRANCIS, Boston, MA (US); Samantika SURY, Boston, MA (US); Alfredo METERE, San Jose, CA (US); David LOMBARD, Los Angeles, CA (US)

(21) Appl. No.: 18/527,220

(22) Filed: Dec. 1, 2023

Related U.S. Application Data
(60) Provisional application No. 63/530,059, filed on Jul. 31, 2023.

(51) Int. Cl. G06F 1/26

(52) U.S. Cl. CPC G06F 1/26

(57) ABSTRACT

Provided are systems, methods, and apparatuses for obtaining first data of a power domain of a system on chip and second data of the power domain, predicting an expected power for the power domain based on the first data and the second data, and applying to the power domain a power level that is selected based on the expected power. The first data is utilization data. The second data is thermal data that includes at least one of a spatial thermal limit or a positional thermal limit of the power domain. The spatial thermal limit is based on at least one of a proximity of the power domain to a component outside the power domain or a power level of the component at a time when the expected power is calculated. The positional thermal limit is based on a location of the power domain on the system on chip.

### CROSS-REFERENCE TO RELATED APPLICATIONS

This application claims the benefit of U.S. Provisional Patent Application Ser. No. 63/530,059, filed Jul. 31, 2023, which is incorporated by reference herein for all purposes.

### FIELD

The disclosure relates generally to memory systems, and more particularly to steering power to components of memory systems.

### BACKGROUND

The present background section is intended to provide context only, and the disclosure of any concept in this section does not constitute an admission that said concept is prior art.

With advances in technology, the size of electronic devices is decreasing while the amount of data is increasing rapidly as data is collected by devices such as mobile devices, Internet of things devices, aerial (remote sensing) devices, software logs, cameras, microphones, radio-frequency identification (RFID) readers, wireless sensor networks, and the like. As the size of electronics decreases, the difficulty of power and thermal management increases. A need remains for systems and methods that improve power and thermal management in electronic devices.

The above information disclosed in this Background section is only for enhancement of understanding of the background of the disclosure and therefore it may contain information that does not constitute prior art.

### SUMMARY

In various embodiments, described herein include systems, methods, and apparatuses for predictive power steering in systems on chip. In particular, a device for managing predictive power steering is disclosed. The device can include: a memory to obtain utilization data of a power domain of the device; a configuration space to obtain thermal data of the power domain; a prediction unit to predict an expected power for the power domain based on the utilization data and the thermal data; and a self-learning intelligent power-drive circuit to apply to the power domain a power level that is selected based on the expected power.

In some aspects, the techniques described herein relate to a method including: obtaining first data of a power domain of a system on chip and second data of the power domain; predicting an expected power for the power domain based on the utilization data and the thermal data; and applying to the power domain a power level that is selected based on the expected power.

In some aspects, the techniques described herein relate to a method, wherein the first data is utilization data and the second data is thermal data, and the thermal data includes at least one of a spatial thermal limit of the power domain or a positional thermal limit of the power domain.

In some aspects, the techniques described herein relate to a method, wherein the spatial thermal limit of the power domain is based on at least one of: an area of the power domain; a proximity of the power domain to a component of the device that is outside the power domain; or a power level of the component at a time when the expected power is calculated.

In some aspects, the techniques described herein relate to a method, wherein the positional thermal limit of the power domain is based on a location of the power domain on the device.

In some aspects, the techniques described herein relate to a method, wherein at least one of the spatial thermal limit or the positional thermal limit of the power domain is based on thermal modeling data obtained from a simulation of the power domain operating at one or more power levels.

In some aspects, the techniques described herein relate to a method, wherein: the expected power is calculated before a first time period, and the power level is applied during the first time period.

In some aspects, the techniques described herein relate to a method, further including predicting an updated expected power for the power domain for a second time period based on at least one of an updated utilization data or an updated thermal data.

In some aspects, the techniques described herein relate to a method, further including applying to the power domain a second power level selected based on the updated expected power, wherein the updated expected power is calculated before or during the second time period, and the second power level is applied during the second time period.

In some aspects, the techniques described herein relate to a method, wherein the utilization data of the power domain is based on a capacitance associated with the power domain and an activity factor of the power domain, the activity factor indicating an activity level of the power domain.

In some aspects, the techniques described herein relate to a method, wherein prediction of the expected power is based on the prediction unit implementing a machine learning model that is trained on power utilization training data from at least one of a system of the power domain, a test system of the power domain, or a simulated system of the power domain.

In some aspects, the techniques described herein relate to a method, further including: generating the utilization data of the power domain; and loading the utilization data of the power domain into a memory of the device.

In some aspects, the techniques described herein relate to a method, wherein the thermal data is obtained during a boot time of the device.

In some aspects, the techniques described herein relate to a device, wherein the device includes a memory to obtain first data of a power domain of the device, a configuration space to obtain second data of the power domain, a prediction unit to predict an expected power for the power domain based on the first data and the second data, and a self-learning intelligent power-drive circuit to apply to the power domain a power level that is selected based on the expected power.

In some aspects, the techniques described herein relate to a device, wherein the first data is utilization data and the second data is thermal data, and the thermal data includes at least one of a spatial thermal limit of the power domain or a positional thermal limit of the power domain.

In some aspects, the techniques described herein relate to a device, wherein the spatial thermal limit of the power domain is based on at least one of: an area of the power domain, a proximity of the power domain to a component of the device that is outside the power domain, or a power level of the component at a time when the expected power is calculated.

In some aspects, the techniques described herein relate to a device, wherein the positional thermal limit of the power domain is based on a location of the power domain on the device. In some aspects, the techniques described herein relate to a device, wherein at least one of the spatial thermal limit or the positional thermal limit of the power domain is based on thermal modeling data obtained from a simulation of the power domain operating at one or more power levels.

In some aspects, the techniques described herein relate to a device, wherein the expected power is calculated before a first time period and the power level is applied during the first time period. In some aspects, the techniques described herein relate to a device, further including the prediction unit configured to predict an updated expected power for the power domain for a second time period based on at least one of an updated utilization data or an updated thermal data.

In some aspects, the techniques described herein relate to a device, further including the self-learning intelligent power-drive circuit configured to apply to the power domain a second power level selected based on the updated expected power, wherein the updated expected power is calculated before or during the second time period and the second power level is applied during the second time period.

In some aspects, the techniques described herein relate to a device, wherein the utilization data of the power domain is based on a capacitance associated with the power domain and an activity factor of the power domain, the activity factor indicating an activity level of the power domain. For example, the activity factor indicates the fraction of time a component (e.g., a power domain, a component of a power domain, a component of a SLIP circuit) is switching (e.g., from 0 to 1 and/or from 1 to 0).

In some aspects, the techniques described herein relate to a device, wherein prediction of the expected power is based on the prediction unit implementing a machine learning model that is trained on power utilization training data from at least one of a system of the power domain, a test system of the power domain, or a simulated system of the power domain (e.g., in relation to execution of one or more applications).

In some aspects, the techniques described herein relate to a device, further including: a compiler to generate the utilization data of the power domain, and an application runtime to load the utilization data of the power domain into a memory of the device. In some aspects, the techniques described herein relate to a device, wherein the thermal data is obtained during a boot time of the device.

In some aspects, the techniques described herein relate to a system, including: at least one processor, wherein the at least one processor is configured to: obtain first data of a power domain of the system and second data of the power domain, predict an expected power for the power domain based on the utilization data and the thermal data, and apply to the power domain a power level that is selected based on the expected power.

In some aspects, the techniques described herein relate to a system, wherein the first data is utilization data and the second data is thermal data, and the thermal data includes at least one of a spatial thermal limit of the power domain or a positional thermal limit of the power domain. In some aspects, the techniques described herein relate to a system, wherein the spatial thermal limit of the power domain is based on at least one of: an area of the power domain, a proximity of the power domain to a component of the system that is outside the power domain, or a power level of the component at a time when the expected power is calculated. In some aspects, the techniques described herein relate to a system, wherein the positional thermal limit of the power domain is based on a location of the power domain on the system.

In some aspects, the techniques described herein relate to a system, wherein at least one of the spatial thermal limit or the positional thermal limit of the power domain is based on thermal modeling data obtained from a simulation of the power domain operating at one or more power levels.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

Accordingly, particular embodiments of the subject matter described herein can be implemented so as to realize one or more of the following advantages: Optimize power delivery predictively. Optimize power delivery based on workloads. Optimize power delivery based on spatial and positional properties of power domains. Further, in some aspects, the disclosed systems can serve to minimize latencies for power state transitions. Additionally, the disclosed systems can serve to increase system performance based on the minimized latencies. Further, the disclosed mechanisms can be applied to a system (e.g., system on chip) to eliminate thermal throttling. In another aspect, the disclosed mechanisms can provide application-aware predictive power steering. In other aspects, the disclosed systems can be used in connection with any suitable system (e.g., system on chip) to provide application-based power delivery to a power domain of a system (e.g., system on chip). Further, in some aspects, the disclosed systems can serve to optimize power delivery based on fine grained voltage and frequency control blocks. Additionally, the disclosed systems can serve to optimize power delivery based on positional and/or spatial thermal awareness of power domains. In another aspect, the disclosed mechanisms can provide software hardware co-design for power management of a system (e.g., system on chip). Further, the disclosed systems and methods can be standardized and applied to a range of systems and related devices while being agnostic to vendor.

### BRIEF DESCRIPTION OF THE DRAWINGS

The above-mentioned aspects and other aspects of the present techniques will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 shows a system including a self-learning intelligent power-drive (SLIP) logic and circuitry that supports predictive power steering, according to embodiments of the disclosure.

FIG. 2 shows details of the system of FIG. 1, according to embodiments of the disclosure.

FIG. 3 shows an example heat map of a system on chip that may be associated with the system of FIG. 1, according to embodiments of the disclosure.

FIG. 4 shows a schematic diagram of a self-learning intelligent power-drive (SLIP) circuit that can be used in association with a system on chip, according to embodiments of the disclosure.

FIG. 5 shows a chart of available power states for a given power domain, according to embodiments of the disclosure.

FIG. 6 depicts a flow diagram illustrating an example power steering process associated with the disclosed systems, in accordance with example embodiments of the disclosure.

FIG. 7 depicts a flow diagram illustrating an example power steering process associated with the disclosed systems, in accordance with example embodiments of the disclosure.

FIG. 8 depicts a flow diagram illustrating an example power steering process associated with the disclosed systems, in accordance with example embodiments of the disclosure.

FIG. 9 depicts a flow diagram illustrating an example power steering process associated with the disclosed systems, in accordance with example embodiments of the disclosure.

FIG. 10 depicts a time flow diagram illustrating an example power steering process associated with the disclosed systems, in accordance with example embodiments of the disclosure.

FIG. 11 shows a schematic diagram of a SLIP circuit that can be used in association with a system on chip, according to embodiments of the disclosure.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification, (including, for example, any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations, may be embodied in a single integrated circuit, a multi-chip module, a single card, system-on-a-chip (e.g., system on chip, system on a chip), or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

When CPUs and accelerators are loosely coupled, power sharing between the CPUs and the accelerators is done at a coarse-grained level that is determined largely by thermal design power (TDP) of the host and devices. Past research, like computational sprinting, attempted to add bursts of computational speed to speed-up powered-down cores in mobile environments. In one device having both big and small cores, a common programming model has either all the big cores executing or all the small cores executing. The techniques described herein provide both hardware and software innovations to support a new programming model.

Computer hardware power management is an increasingly pressing issue as computers are consuming more power to meet the performance demands. As technology nodes shrink, transistor density increases and so does thermal density. The arrival of 3D die stacking in system on chip (SOC) packaging adds thermal complexity. There are several power efficiency and heat dissipation challenges that arise as a result of increased transistor density.

The topic of power management may be significant for high performance computing at an exa-scale and beyond, such as embedded devices, automotive systems, mobile robots, etc.

Power management mechanisms in most systems on chip (SOCs) may be designed based on a hardware focus and are generally not application aware. For example, designs that use clock-gating may be based on what happens in instruction pipelines. Voltage and frequency scaling (VFS) may happen largely as a response to execution of high-power consuming instructions to prevent SOCs (e.g., power domains of SOCs) from entering into thermal issues (e.g., exceeding thermal limits).

The following definitions aid the discussion herein:

Power domain may refer to a sub-block on a system on chip (SOC) for which power may be individually controlled using voltage frequency scaling (VFS), power gating, clock gating, etc. Examples of power domains include: a core neighborhood, a big core, a small core, network on chip (NOC), input/output controller, memory controller, etc.

P-state may refer to a power state that specifies a particular voltage and frequency at which to operate. A power state may include an active power state (e.g., active power) and an idle power state (e.g., no power),

Power steering may refer to a capability to deliver or steer power (e.g., steer additional power, increase power) to designated power domains while transitioning lesser utilized domains to lower power or to idle states (e.g., decrease power, remove power).

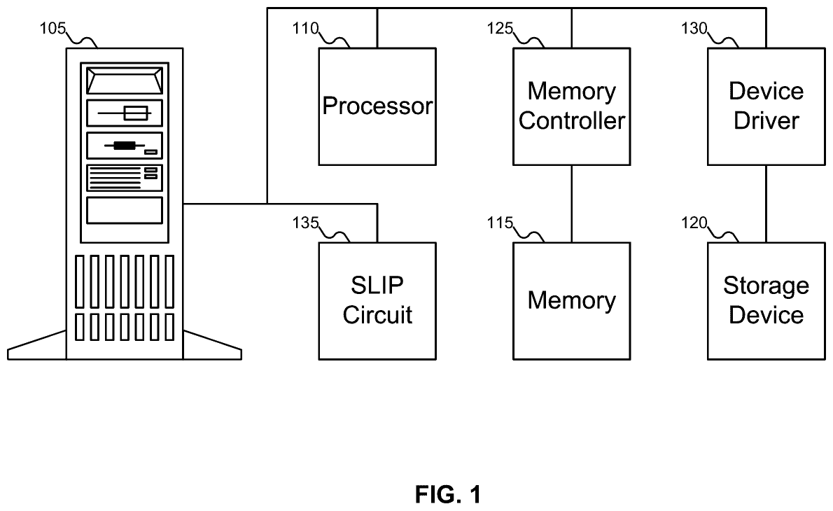

FIG. 1 shows a system including a self-learning intelligent power-drive (SLIP) logic and circuitry that supports predictive power steering, according to embodiments of the disclosure. In FIG. 1, machine 105, which may also be termed a host or a system (e.g., system on chip), may include processor 110, memory 115, storage device 120, memory controller 125, device driver 130, and SLIP circuit 135.

Processor 110 may be any variety of processor. (Processor 110, along with the other components discussed below, are shown outside the machine for case of illustration: embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture (e.g., RISC-V) or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Storage device 120 may be accessed using device driver 130.

Processor 110 and storage device 120 may be connected to a fabric. The fabric may be any fabric along which information may be passed. The fabric may include fabrics that may be internal to machine 105, and which may use interfaces such as Peripheral Component Interconnect Express (PCIe), Serial AT Attachment (SATA), Small Computer Systems Interface (SCSI), among others. The fabric may also include fabrics that may be external to machine 105, and which may use interfaces such as Ethernet, InfiniBand, or Fibre Channel, among others. In addition, the fabric may support one or more protocols, such as Non-Volatile Memory (NVM) Express (NVMe), NVMe over Fabrics (NVMe-oF), or Simple Service Discovery Protocol (SSDP), among others.

In the illustrated example, SLIP circuit 135 includes any combination of logic, circuitry, software, firmware, and/or hardware to provide predictive power steering in a given system (e.g., a system of machine 105). In one or more examples, SLIP circuit 135 obtains utilization data of a power domain (e.g., of a system of machine 105) and thermal data of the power domain. In some cases, SLIP circuit 135 predicts an expected power for the power domain based on the utilization data and the thermal data. In variations, SLIP circuit 135 applies to the power domain a power level that is selected based on the expected power. Accordingly, SLIP circuit 135 predictively optimizes power delivery for a system of machine 105.

The host may be implemented with any type of apparatus that may be configured as a host including, for example, a server such as a compute server, a storage server, storage node, a network server, and/or the like, a computer such as a workstation, a personal computer, a tablet, a smartphone, and/or the like, or any combination thereof. The device may be implemented with any type of apparatus that may be configured as a device including, for example, an accelerator device, a storage device, a network device, a memory expansion and/or buffer device, a graphics processing unit (GPU), a neural processing unit (NPU), a tensor processing unit (TPU), and/or the like, or any combination thereof.

Any communication between devices (e.g., host and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, the system illustrated herein may include one or more additional apparatus having one or more additional communication interfaces.

In an embodiment in which the device is implemented as a storage device, the storage device 120 may include any type of nonvolatile storage media based, for example, on solid state media (e.g., a solid state drive (SSD)), magnetic media (e.g., a hard disk drive (HDD)), optical media, and/or the like, or any combination thereof. For example, in some embodiments, the storage device 120 may be implemented as an SSD based on not-AND (NAND) flash memory, persistent memory such as cross-gridded nonvolatile memory, memory with bulk resistance change, phase change memory (PCM), and/or the like, or any combination thereof. Any such storage device may be implemented in any form factor such as 3.5 inch, 2.5 inch, 1.8 inch, M.2, Enterprise and Data Center SSD Form Factor (EDSFF), NF1, and/or the like, using any connector configuration such as SATA, SCSI, SAS, U.2, M.2, and/or the like. Any such storage device may be implemented entirely or partially with, and/or used in connection with, a server chassis, server rack, dataroom, datacenter, edge datacenter, mobile edge datacenter, and/or any combinations thereof.

Any of the functionality described herein, including any of the host functionality, device functionally, and/or the like, may be implemented with hardware, software, firmware, or any combination thereof including, for example, hardware and/or software combinational logic, sequential logic, timers, counters, registers, state machines, volatile memories such as dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), graphics processing units (GPUs), neural processing units (NPUs), tensor processing units (TPUs) and/or the like, executing instructions stored in any type of memory. In some embodiments, one or more components may be implemented as a system-on-chip (SOC).

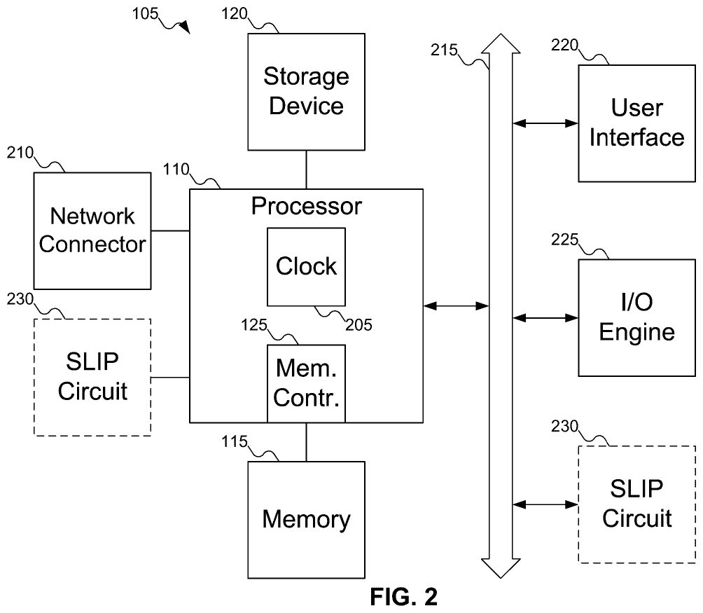

FIG. 2 shows details of the system of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components. As shown, processors 110 may be coupled to SLIP circuit 230, which may be an example of SLIP circuit 135. Additionally, or alternatively, processors 110 may be connected to buses 215, to which may be attached SLIP circuit 230.

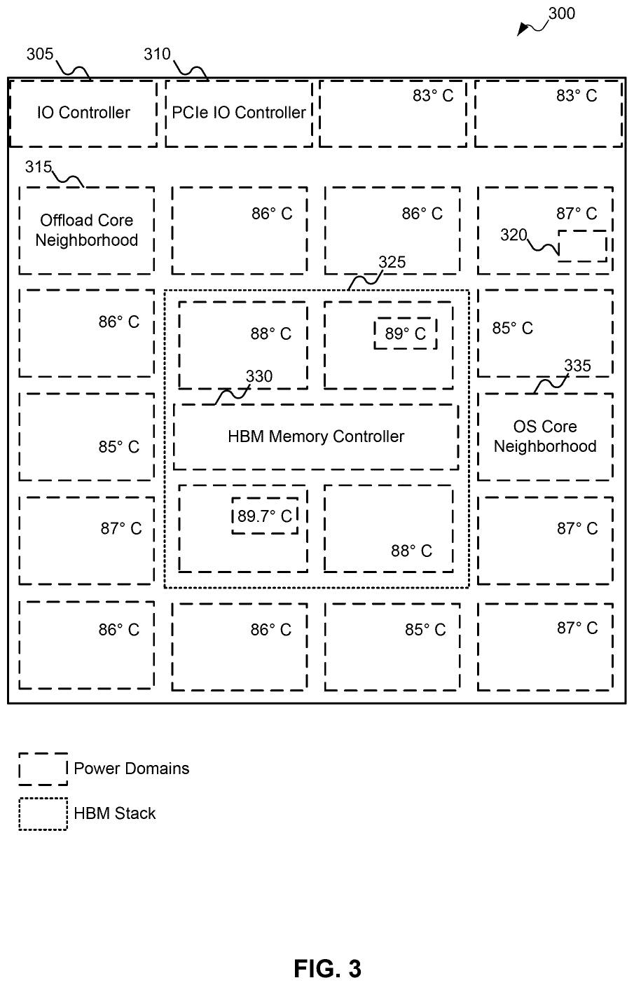

FIG. 3 shows an example of a system on chip that may be associated with the system of FIG. 1, according to embodiments of the disclosure.

In the illustrated example, FIG. 3 depicts a heat map of a system on chip (SOC) 300. The SOC 300 includes input/output (IO) controller 305, peripheral component interconnect express (PCIe) IO controller 310, an offload core neighborhood 315, a vision processing unit (VPU) 320, a high-bandwidth memory (HBM) stack 325, a HBM memory controller 330, and an operating system (OS) core neighborhood 335.

In some cases, a VPU of SOC 300 (e.g., VPU 320) that is in an offload core neighborhood (e.g., offload core neighborhood 315) has a higher dynamic capacitance (Cdyn) than other execution units of SOC 300. In some examples, core neighborhoods under the HBM stack 325 have a lower thermal design power (TDP) limit than other neighborhoods of SOC 300. In one or more examples, a SLIP circuit (e.g., SLIP circuit 135, SLIP circuit 230) may receive data that includes information such as dynamic capacitance, relative dynamic capacitance (e.g., higher dynamic capacitance, lower dynamic capacitance compared to another component or region), thermal design power, relative thermal design power (e.g., higher thermal design power, lower thermal design power compared to another component or region).

In one or more variations, the HBM stack 325 is stacked on top of a logic die of the SOC 300. In some examples, neighborhoods outside of the HBM stack 325 (e.g., offload core neighborhood 315, OS core neighborhood 335) may be situated adjacent to (e.g., above, under, beside) a dummy part of the SOC 300 (e.g., dummy silicon), which allows for improved heat dissipation. In one or more examples, a SLIP circuit (e.g., SLIP circuit 135, SLIP circuit 230) may receive thermal data that includes dynamic capacitance of one or more power domains, thermal limits of one or more power domains, etc. Additionally, or alternatively, a SLIP circuit may receive thermal data that includes spatial and/or positional information of a power domain (e.g., a power domain or a component of a power domain is stacked on top of a logic die, is beside a logic die, is adjacent to dummy silicon, etc.).

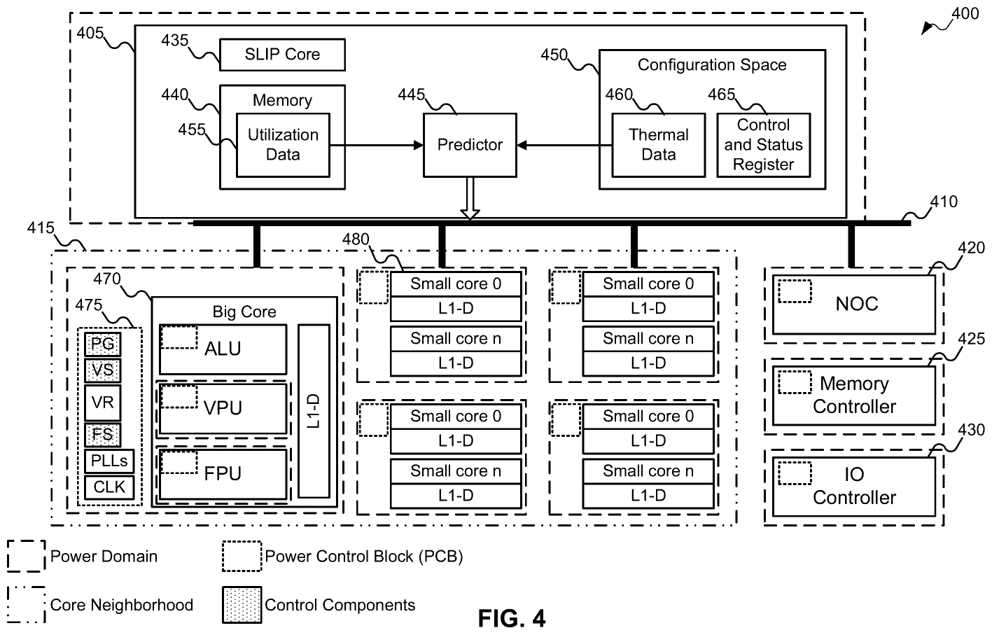

FIG. 4 shows an example schematic diagram of a self-learning intelligent power-drive (SLIP) circuit that can be used in association with a system (e.g., system on chip), according to embodiments of the disclosure.

In the illustrated example, FIG. 4 depicts a system on chip (SOC) 400. As shown, the SOC 400 includes a SLIP circuit 405, a power control bus 410, a core neighborhood 415, a network on chip (NOC) 420, a memory controller 425, and an input/output (IO) controller 430. In some examples, the power control bus 410 is a low-latency power control bus that improves communication between the SLIP circuit 405 and the individual power domains of the SOC 400.

In the illustrated example, the SLIP circuit 405 includes a SLIP core 435 (e.g., one or more SLIP cores that include at least SLIP core 435), memory 440 (e.g., a static random-access memory, SLIP memory, one or more SLIP memories), predictor 445 (e.g., a prediction unit), a configuration space 450. The SLIP circuit 405 and components thereof (e.g., SLIP core 435, memory 440, predictor 445, and/or configuration space 450) include any combination of hardware, logical circuitry, firmware, and/or software to perform predictive power steering in a given system (e.g., SOC 400). For example, the predictor 445 may be implemented in software, implemented in hardware, or implemented in a combination of software and hardware.

As shown, the memory 440 includes utilization data 455. In one or more examples, the configuration space 450 includes thermal data 460 and a control and status register 465 (e.g., one or more control and status registers). In one or more examples, the SLIP circuit 405 includes a hardware block of the SOC 400 that is configured to steer power across one or more components of the SOC 400 by proactively setting power states (e.g., P-states) for individual power domains of the SOC 400. Thus, the SLIP circuit 405 maximizes performance of the SOC 400 for a given power envelope. The SLIP circuit 405 prevents thermal runaway based on positional and spatial thermal properties of regions of the SOC 400.

In one or more examples, the configuration space 450 of SOC 400 may be an addressable space of memory (e.g., configuration address space). In some cases, configuration space 450 may be provided by one or more configuration registers. In the illustrated example, the configuration space 450 may be provided by one or more configuration registers of the SLIP circuit 405. In some cases, the configuration space 450 may be configured to include some number of bytes (e.g., up to 256 bytes). In some examples, a first set of bytes (e.g., 40 bytes) may be the header of the configuration space 450. The remaining bytes of the configuration space 450 may be a device dependent region (e.g., reserved for operation of the SLIP circuit 405). In some cases, the remaining bytes of the configuration space 450 may store the thermal data 460 and/or the control and status register 465. In one or more variations, the configuration space 450 may be accessed with read/write configuration cycles. In some cases, the configuration space 450 may be extended to some number of bytes (e.g., up to 4096 bytes).

In the illustrated example, the core neighborhood 415 includes a big core 470, and one or more small cores 480. In one or more examples, the big core 470 includes level 1 data-side cache (L1-D), an arithmetic logic unit (ALU), a vision processing unit (VPU), floating point unit (FPU). As shown, the one or more small cores 480 of the SOC 400 include L1-D cache. In some cases, L1-D cache is configured to hold data for a core, processing unit, and/or logical unit of a given power domain of SOC 400.

In the illustrated example, the power domains of the SOC 400 include at least the SLIP circuit 405, the big core 470, the VPU of the big core 470, the FPU of the big core 470, each of the one or more small cores 480, the NOC 420, the memory controller 425, and/or the IO controller 430. As shown, the depicted power domains may include the power domains of the one or more small cores 480 where each small core power domain includes one or more small cores (e.g., small core 0 to small core n, each with L1-D cache). In some cases, a power domain may include a sub-power-domain. For example, as shown, the power domain of the big core 470 may include the power domain of the VPU and/or the power domain of the FPU.

In one or more examples, the SLIP circuit 405 may power off one or more power domains (e.g., powered off completely). For example, the SLIP circuit 405 may power off (e.g., based on the predictions of the predictor 445) at least one of the power domains of the big core 470, the power domain of the VPU, and/or the power domain of the FPU. Additionally, or alternatively, the predictor 445 may power off at least one of the power domains of the one or more small cores 480, the power domain of the NOC 420, the power domain of the memory controller 425, and/or the power domain of the IO controller 430. In some cases, the SLIP circuit 405 sets individual power domains to a power state predictively (e.g., set a power state P_{(V, f)} from a reference power state P₀ of the SOC 400). In some cases, the SLIP circuit 405 may be configured to disable predictive power steering (e.g., disable programmatically).

In some examples, one or more components of the SOC 400 include a power control block. In the illustrated example, the big core 470 includes power control block 475. Additionally, or alternatively, the one or more small cores 480, the NOC 420, the memory controller 425, and/or the IO controller 430 include a power control block. As shown, the power control block 475 includes at least one of power gating (PG), voltage scaler (VS), a voltage regulator (VR), frequency scaler (FS), one or more phase-locked loops (PLLs), and/or a clock (CLK). As indicated, the control components of the power control block 475 include the at least one of power gating, the voltage scaler, and/or the frequency scaler. In one or more examples, each power control block of the SOC 400 includes at least one of power gating, voltage scaler, a voltage regulator, frequency scaler, one or more phase-locked loops, and/or a clock.

In one or more examples, the utilization data 455 is generated during a compile time associated with the SOC 400 (e.g., a compile time the SOC 400). In variations, the utilization data 455 is loaded into the memory 440 during a runtime associated with the SOC 400 (e.g., during a runtime of the SOC 400, during runtime of an application, runtime of an operating system, runtime of a firmware configuration, after a boot time of SOC 400, etc.).

In one or more examples, the thermal data 460 and/or the control and status register 465 is loaded during a boot-time associated with the SOC 400 (e.g., during a boot-time of the SOC 400). In implementations, at least a portion of the thermal data 460 may be loaded in the control and status register 465 (e.g., during boot-time). In variations, the thermal data 460 includes thermal property information obtained and/or loaded into the configuration space 450 during boot-time. In one or more examples, the thermal data 460 may be obtained from thermal modeling data and/or may be programmable through the configuration space 450 at boot-time. In variations, the control and status register 465 may include firmware configuration to tune and/or calibrate one or more operations of the SLIP circuit 405 (e.g., self-learning real time updates to a prediction model).

In one or more examples, the SLIP circuit 405 obtains the utilization data 455 of a power domain (e.g., of the memory controller 425) and the thermal data 460 of the same power domain. The SLIP circuit 405 predicts an expected power for the power domain based on an analysis of the utilization data and the thermal data. The SLIP circuit 405 then applies to the power domain a power level that is selected based on the expected power. In some cases, the predictor 445 steers the power based on providing the expected power (e.g., maintaining, increasing, decreasing power) to a power control block (e.g., power control block 475) of the given power domain.

The thermal data 460 includes at least one of a spatial thermal limit of the power domain or a positional thermal limit of the power domain. The spatial thermal limit of the power domain is based on at least one of a proximity of the power domain to one or more components (e.g., other power domains, components of other power domains) of the SOC 400 that are outside the power domain (e.g., the NOC 420 and/or the IO controller 430 adjacent to the memory controller 425) and/or a power level of the one or more components at a time when the expected power is calculated. The positional thermal limit of the power domain is based on a location of the power domain on the SOC 400 (e.g., the position of the memory controller 425 on the SOC 400, positioned on a peripheral of SOC 400, positioned in the center of SOC 400, etc.). At least one of the spatial thermal limit or the positional thermal limit of the power domain is based on thermal modeling data obtained from a simulation of the execution of one or more applications in relation to the power domain operating at one or more power levels. Additionally, or alternatively, the spatial thermal limit or the positional thermal limit of the power domain is based on thermal modeling data obtained from data gathered in real-time during operation of the SLIP circuit 405. In some examples, prediction of expected power for a power domain is based on the predictor 445 implementing a machine learning model that is trained on power utilization training data and/or thermal modeling data from at least one of a system of the power domain, a test system of the power domain, or a simulated system of the power domain (e.g., in relation to the execution of one or more applications, one or more workloads, one or more power levels applied to the power domain, etc.). In some examples, the machine learning may use re-enforced training to improve the prediction model. Additionally, or alternatively, the machine learning model is trained on power utilization data and/or thermal modeling data obtained from real-time data gathered during operation of the SLIP circuit 405.

In one or more implementations, the SLIP circuit 405 calculates the expected power before or during a first time period (e.g., after a boot time, during a runtime) and the SLIP circuit 405 applies the power level during the first time period. In some cases, the predictor 445 is configured to predict an updated expected power for the power domain for a second time period (e.g., after the first time) based on at least one of an update to the utilization data 455 and/or an update to the thermal data 460. In one or more examples, the SLIP circuit 405 applies to the power domain a second power level selected based on the updated expected power. In some cases, the updated expected power is calculated before the second time period and/or the second power level is applied during the second time period.

In one or more implementations, the utilization data 455 of a given power domain is based on a capacitance associated with the power domain (e.g., in relation to the execution of one or more applications). Additionally, or alternatively, the utilization data 455 is based on an activity factor of a power domain (e.g., in relation to the execution of one or more applications). In some cases, the activity factor indicates an activity level of the power domain (e.g., based on execution of one or more applications). In some examples, a SLIP compiler (e.g., stored in memory 440 and/or executed by or in conjunction with the SLIP core 435 and/or an application runtime of the SLIP core 435) generates the utilization data 455 of the power domain. Additionally, or alternatively, an application runtime of the SOC 400 loads the utilization data 455 of the power domain into the memory 440. In some cases, the thermal data 460 is obtained during a boot time of the SLIP circuit 405 and stored in the configuration space 450.

In some examples, the SLIP circuit 405 may set P-states without actively monitoring thermal sensor data of the SOC 400 or without actively monitoring instructions in an execution pipeline of the SOC 400. The SLIP circuit 405 provides predictive power steering instead of the reactive power throttling of conventional systems. The SLIP circuit 405 provides predictive setting of idle states (e.g., power gating, clock gating) and active states for individual power domains of the SOC 400. Thus, the SLIP circuit 405 provides the ability to steer power to various areas of the SOC 400 where and when the power is most needed while remaining under thermal density limits of the SOC 400 (e.g., of each power domain of the SOC 400). In some cases, the SLIP compiler creates power domain utilization data (e.g., utilization data 455). In some cases, the SLIP compiler creates at least one iteration of the utilization data 455 for at least one time step (e.g., a next time step). The utilization data 455 may include information on what power domains of the SOC 400 would be utilized (e.g., in a given time step). In some cases, the utilization data 455 includes an activity factor for one or more power domains of the SOC 400 (e.g., for each power domain being utilized). In some examples, an application runtime loads the utilization data 455 onto the memory 440. In some cases, the application runtime includes hardware, firmware, and/or software (e.g., hardware configuration, firmware configuration, software configuration) that enables an application to run (e.g., in relation to the SOC 400, on the SOC 400).

In one or more examples, the SLIP circuit 405 uses the utilization data 455 to predict a P-state for one or more power domains based on a pre-trained model obtained from simulation or other mechanisms. In one embodiment, the prediction mechanism (e.g., prediction model) may include a hardware state-machine that is based on artificial intelligence (AI) based inference. In some examples, the utilization data 455 is based on execution of one or more applications. In some cases, the SLIP circuit 405 may combine domain utilization data from multiple applications associated with the SOC 400.

One or more aspects of the SLIP circuit 405 is based on knowledge of positional & spatial thermal properties of the SOC 400 (e.g., thermal data 460). The SLIP circuit 405 prevents thermal runaway events by using knowledge of the thermal limits of power domains of a given SOC. In one or more examples, thermal data 460 includes a thermal limit of a power domain (e.g., thermal density limits of one or more power domains of the SOC 400, one or more thermal limits of each power domain, etc.). The thermal limits of a power domain may be based on the position of a power domain on the SOC 400 and what components are adjacent to the power domain on the SOC 400 (e.g., spatial adjacency of components of the SOC 400 that are beside, above, and/or below the power domain). For example, 3D-die stacking of an SOC die may present varying thermal properties of similar logical units. Such thermal properties may be obtained from thermal modeling data and included in thermal data 460. In some cases, thermal data 460 may be programmable through the configuration space 450 (e.g., during boot-time, via machine mode code).

In some examples, the SLIP circuit 405 uses the thermal data 460 to prevent thermal runaway events and avoid thermal throttling, thereby avoiding performance penalties of conventional systems. In some cases, thermal data 460 includes thermal density limits of power domains. Additionally, or alternatively, thermal data 460 includes heat dissipation capabilities of power domains of the SOC 400 based on the physical architecture and placement of each power domain. Additionally, or alternatively, thermal data 460 includes area and/or dynamic capacitance of individual power domains (C_{dyn}). In some examples, the thermal data 460 enables the SLIP circuit 405 to provide tunability for manufacturing variation.

Table 1 provides an example of positional and spatial data of thermal data 460.

TABLE 1

| Power domain | Address | Cdyn (nF) | Max Pwr (W) |
|---|---|---|---|
| OS core neighborhood | 0100h | 523 | 1.5 |
| VPU in big-core of OS core | 0101h | 150 | 0.8 |
| Accelerator neighborhood 1 | 0200h | 302 | 1.2 |
| Accelerator neighborhood 2 | 0030h | 314 | 1.3 |
| Memory Controller | 0040h | 31 | 0.65 |
| IO controller | 0050h | 52 | 1.6 |

While performing a P-state prediction, SLIP circuit 405 (in conjunction with predictor 445) calculates expected power for one or more power domains using utilization data 455 (e.g., activity factor information provided by runtime, provided by a runtime application) and thermal data 460 (e.g., thermal property information obtained during boot-time). The utilization data 455 and the thermal data 460 may be used by the SLIP circuit 405 to maintain thermal limits of a given power domain. Thus, the SLIP circuit 405 predictively prevents thermal run-away of the SOC 400.

In one or more examples, the SLIP circuit 405 provides application-aware predictive power steering. The SLIP circuit 405 provides fine grained voltage and frequency control blocks (e.g., the power control block 475). Based on the techniques described herein, the SLIP circuit 405 provides power steering based on positional and spatial thermal awareness. Additionally, or alternatively, the SLIP circuit 405 provides power delivery optimization based on workloads and/or eliminates thermal throttling. In some cases, the SLIP circuit 405 takes advantage of spatial properties of the SOC 400 to maximize power delivery performance.

The SLIP circuit 405 provides a self-learning intelligent power delivery that does not rely on real time temperature sensor data or power monitors from the sub-blocks to infer set point. Instead, the SLIP circuit 405 may use a pre-trained model to infer a set-point. In some examples, the SLIP circuit 405 provides power delivery based on fine grained power-domains and low latency controls (e.g., on-package VR technology and PLLs of the power control block 475). In one or more examples, the SLIP circuit 405 provides power delivery based on two-dimensional P-states for fine grained dynamic voltage and frequency scaling (DVFS) instead of conventional single-dimension scaling.

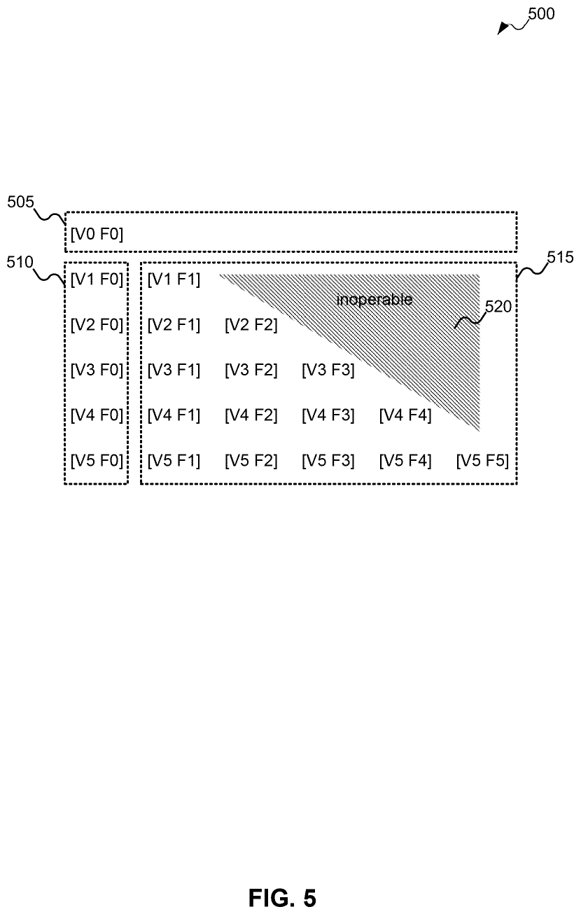

FIG. 5 shows a chart 500 of available power states for a given power domain, according to embodiments of the disclosure. In the illustrated example, the chart 500 depicts multiple two-dimensional voltage frequency pairs (e.g., voltage frequency pairs available for a given power domain). In some examples, each power domain of a given system (e.g., SOC 400) includes a chart (e.g., chart 500) that is unique to a given power domain. As one example, the chart 500 may be based on modeling data of the power domain of the big core 470, while a second chart different from chart 500 (e.g., different voltage frequency pairs, different values for voltage frequency pairs, different available voltage frequency pairs, etc.) may be based on modeling data of the power domain of the NOC 420, etc.

In the illustrated example, the chart 500 may include a power gated zone 505, an idle state zone 510, an active state zone 515. As shown, the power gated zone 505 includes the [V0 F0] voltage frequency pair. The idle state zone 510 may include voltage pairs where the frequency is zero and the voltage is non-zero (e.g., all F0 frequency pairs except [V0 F0]).

In the illustrated example, the active state zone 515 may include voltage pairs where the frequency is non-zero (e.g., the depicted F1, F2, F3, F4, and/or F5 voltage frequency pairs). In one or more examples, the active state zone 515 includes voltage pairs that may be applied to a power domain. As shown, the active state zone 515 includes an inoperable zone 520, a zone where some voltage frequency pairs in the active state zone 515 are not available to be applied to a power domain.

Conventional 1-dimensional power states provide a one-to-one relationship between voltage and frequency (e.g., one possible voltage level for a first frequency level, one possible voltage level for a second frequency level, etc.). The chart 500 depicts two-dimensional power states where a frequency level may be paired with one or more different voltage levels. For example, as shown, a given frequency level (e.g., F1) may include multiple voltage combinations (e.g., V1, V2, V3, V4, V5, etc.).

In one or more examples, voltage frequency pair [V1 F1] may be the slowest corner (e.g., setup-time closure). In the illustrated example, at least one voltage frequency pair (e.g., voltage frequency pair [V3 F2]) may be a base power state of a given system on chip. In one or more variations, voltage frequency pair [V5 F5] may be a fastest corner (e.g., hold-time closure).

In one or more examples, the total power of a domain may be calculated (e.g., by predictor 445) based on the following equation:

$$Total Power of Domain = α {C}_{L} {V}^{2} f + {VI}_{leak}$$

where α is an activity factor of the power domain, C_{L} is a load capacitance of a power domain, V is a voltage level, f is a frequency level, and Iₗₑₐₖ is a current leak of the power domain. In the equation above, the product of the activity factor α and the load capacitance C_{L} may be referred to as a dynamic capacitance C_{dyn}, resulting in the equation above being rewritten as follows:

$$Total Power of Domain = {C}_{dyn} {V}^{2} f + {VI}_{leak}$$

Conventional techniques of power delivery have evolved over the years, and methods have been developed to improve efficiency and performance of such methods. Conventional techniques involve monitoring various parameters, such as CPU utilization, temperature consumption, and power consumption. Based on measurements of these parameters, an SOC makes decisions to adjust the voltage and frequency levels. Such conventional techniques may be centered around power or thermal throttling to scale down frequency and voltage with active monitoring, when workloads utilize execution units with large dynamic capacitance (C_{dyn}) and scale back up when safe to do so. This is done in order to operate safely below the SOC TDP without causing a catastrophic thermal event. Conventional mechanisms tend to be reactive instead of predictive and have large latencies for the P-state transitions, which adversely impacts performance.

The techniques described herein (e.g., the techniques of the SLIP circuit 405) avoid reactive power throttling. Instead, power is proactively and predictively steered in the SOC 400 without active monitoring. The predictive power steering of the SLIP circuit 405 focuses on system efficiency and performance.

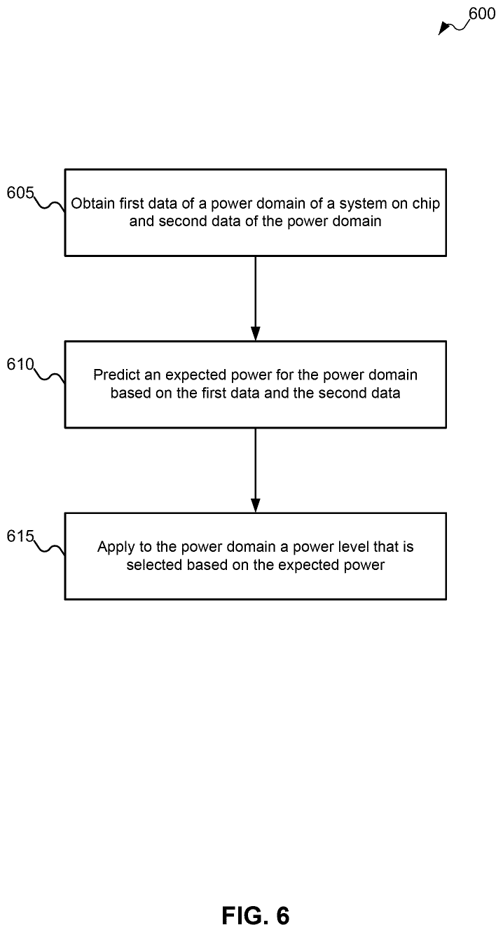

FIG. 6 depicts a flow diagram illustrating an example power steering process associated with the disclosed systems, in accordance with example embodiments of the disclosure. In some configurations, the method 600 may be implemented by the SLIP circuit 135 of FIG. 1, the SLIP circuit 230 of FIG. 2, and/or the SLIP circuit 405 of FIG. 4. In some configurations, the method 600 may be implemented in conjunction with machine 105, components of machine 105, or any combination thereof. The method 600 is just one implementation and one or more operations of the method 600 may be rearranged, reordered, omitted, and/or otherwise modified such that other implementations are possible and contemplated.

At 605, the method 600 may include obtaining first data of a power domain of a system on chip and second data of the power domain. For example, the SLIP circuit 405 may obtain utilization data 455 (e.g., via a runtime application of SOC 400) and obtain the thermal data 460 during a boot time of SOC 400.

At 610, the method 600 may include predicting an expected power for the power domain based on the first data and the second data. For example, the SLIP circuit 405, in conjunction with the predictor 445, may analyze the utilization data 455 and the thermal data 460 and predict an expected power for the power domain based on the analysis.

At 615, the method 600 may include applying to the power domain a power level that is selected based on the expected power. For example, the SLIP circuit 405 may select a power level based on the expected power predicted at 610, and apply the selected power level to a power domain of SOC 400 (e.g., the power domain of the VPU of the big core 470).

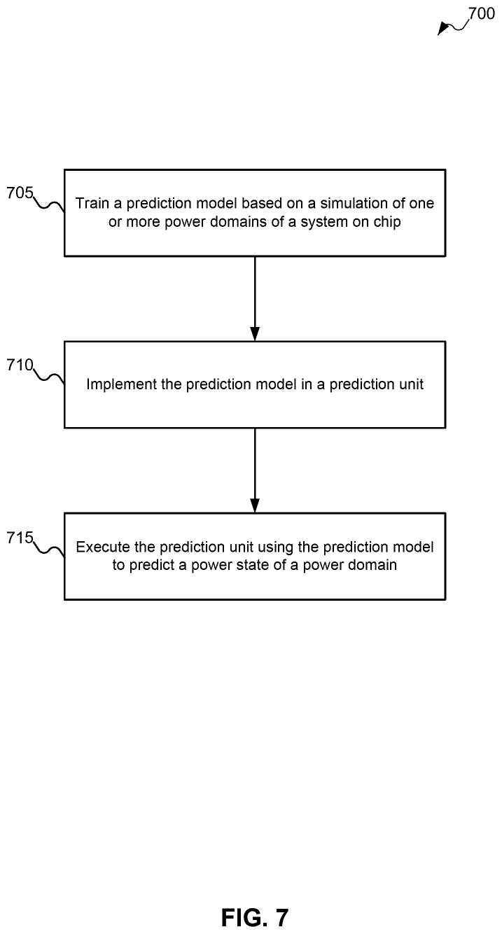

FIG. 7 depicts a flow diagram illustrating an example power steering process associated with the disclosed systems, in accordance with example embodiments of the disclosure. In some configurations, the method 700 may be implemented by the SLIP circuit 135 of FIG. 1, the SLIP circuit 230 of FIG. 2, and/or the SLIP circuit 405 of FIG. 4. In some configurations, the method 700 may be implemented in conjunction with machine 105, components of machine 105, or any combination thereof. The method 700 is just one implementation and one or more operations of the method 700 may be rearranged, reordered, omitted, and/or otherwise modified such that other implementations are possible and contemplated.

At 705, the method 700 may include training a prediction model based on a simulation of one or more power domains of a system on chip. For example, the SLIP circuit 405 may simulate the execution of one or more applications while a power domain operates at one or more power levels. Additionally, or alternatively, the SLIP circuit 405 may train a prediction model based on data captured from a system on chip (e.g., SOC 400) in operation and/or data from a simulated system on chip. In some cases, the training may include training based on a machine learning model (e.g., that uses re-enforced training). In one or more examples, the prediction mechanism (e.g., prediction model) of the predictor 445 may include a hardware state-machine that is based on AI inference.

At 710, the method 700 may include implementing the prediction model in a prediction unit. For example, the SLIP circuit 405 may implement the prediction model in the predictor 445 of FIG. 4.

At 715, the method 700 may include executing the prediction unit using the prediction model to predict a power state of a power domain. For example, the SLIP circuit 405 may use the utilization data 455 and/or the thermal data 460 to predict a P-state for a power domain based on a pre-trained model obtained from simulation or other mechanisms.

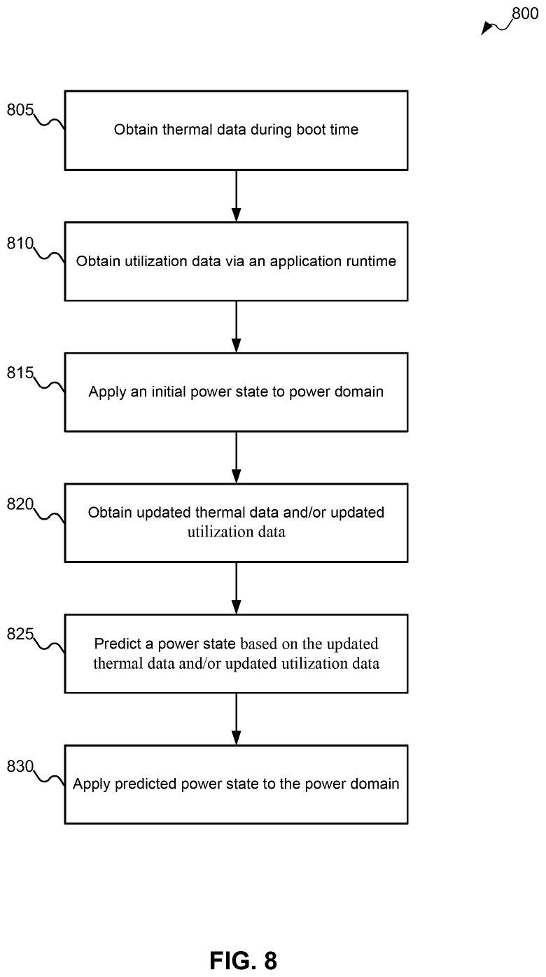

FIG. 8 depicts a flow diagram illustrating an example power steering process associated with the disclosed systems, in accordance with example embodiments of the disclosure. In some configurations, the method 800 may be implemented by the SLIP circuit 135 of FIG. 1, the SLIP circuit 230 of FIG. 2, and/or the SLIP circuit 405 of FIG. 4. In some configurations, the method 800 may be implemented in conjunction with machine 105, components of machine 105, or any combination thereof. The method 800 is just one implementation and one or more operations of the method 800 may be rearranged, reordered, omitted, and/or otherwise modified such that other implementations are possible and contemplated.

At 805, the method 800 may include obtaining thermal data during boot time. For example, the SLIP circuit 405 may obtain thermal data 460 (e.g., thermal property information associated with one or more power domains) during a boot time of the SOC 400.

At 810, the method 800 may include obtaining utilization data via an application runtime. For example, the SLIP circuit 405 may obtain utilization data 455 (e.g., activity factor information associated with one or more power domains) via an application runtime of the SOC 400.

At 815, the method 800 may include applying an initial power state to power domain. For example, the SLIP circuit 405 may be configured to apply an initial power state (e.g., default power state, preconfigured power state, etc.) to a power domain (e.g., after the SOC 400 boots).

At 820, the method 800 may include obtaining updated thermal data and/or updated utilization data. For example, the SLIP circuit 405 may obtain an update of the thermal data 460 and/or an update of the utilization data 455 (e.g., after applying the initial power state).

At 825, the method 800 may include predicting a power state based on the updated thermal data and/or updated utilization data. For example, the SLIP circuit 405, in conjunction with the predictor 445, may predict a power state for the power domain based on the update of the thermal data 460 and/or the update of the utilization data 455.

At 830, the method 800 may include applying the predicted power state to the power domain. For example, the SLIP circuit 405 may apply the predicted power state to a power domain of the SOC 400 (e.g., the power domain of the IO controller 330.

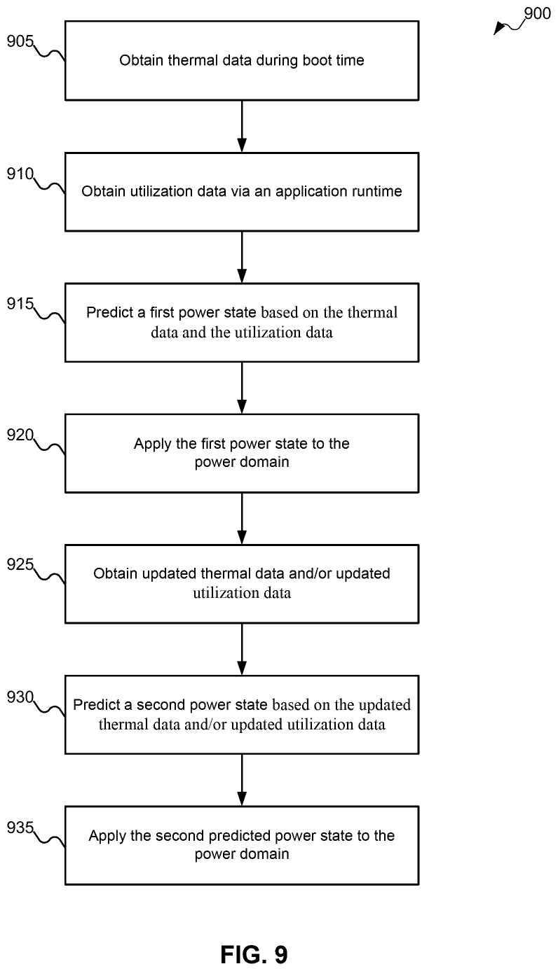

FIG. 9 depicts a flow diagram illustrating an example power steering process associated with the disclosed systems, in accordance with example embodiments of the disclosure. In some configurations, the method 900 may be implemented by the SLIP circuit 135 of FIG. 1, the SLIP circuit 230 of FIG. 2, and/or the SLIP circuit 405 of FIG. 4. In some configurations, the method 900 may be implemented in conjunction with machine 105, components of machine 105, or any combination thereof. The method 900 is just one implementation and one or more operations of the method 900 may be rearranged, reordered, omitted, and/or otherwise modified such that other implementations are possible and contemplated.

At 905, the method 900 may include obtaining thermal data during boot time. For example, during a boot time of SOC 400, the SLIP circuit 405 may obtain the thermal data 460.

At 910, the method 900 may include obtaining utilization data via an application runtime. For example, the SLIP circuit 405 may obtain the utilization data 455 via an application runtime of the SOC 400.

At 915, the method 900 may include predicting a first power state based on the thermal data and/or the utilization data. For example, the SLIP circuit 405, in conjunction with the predictor 445, may use the utilization data 455 and the thermal data 460 to predict a first power state for a power domain of the SOC 400.

At 920, the method 900 may include applying the first power state to power domain. For example, the SLIP circuit 405 may apply the first power state to the power domain (e.g., at a first time or during a first time period).

At 925, the method 900 may include obtaining updated thermal data and/or updated utilization data. For example, the SLIP circuit 405 may obtain an adjustment to the thermal data 460 and/or an adjustment to the utilization data 455.

At 930, the method 900 may include predicting a second power state based on the updated thermal data and/or updated utilization data. For example, the SLIP circuit 405, in conjunction with the predictor 445, may use an update to the utilization data 455 and/or an update to the thermal data 460 to predict a second power state for the power domain of the SOC 400.

At 935, the method 900 may include applying the second power state to the power domain. For example, the SLIP circuit 405 may apply the second power state to the power domain (e.g., at a second time after the first time or during a second time period after the first time period). In one or more examples, the first power state or the second power state may include a voltage level (e.g., V0 to V5) and/or a frequency level (e.g., F0 to F5). In some cases, the first power state or the second power state may include an idle state (e.g., V0, F0). In some cases, the voltage level of the second power state may be the same or different from the voltage level of the first power state. Additionally, or alternatively, the frequency level of the second power state may be the same or different from the frequency level of the first power state.

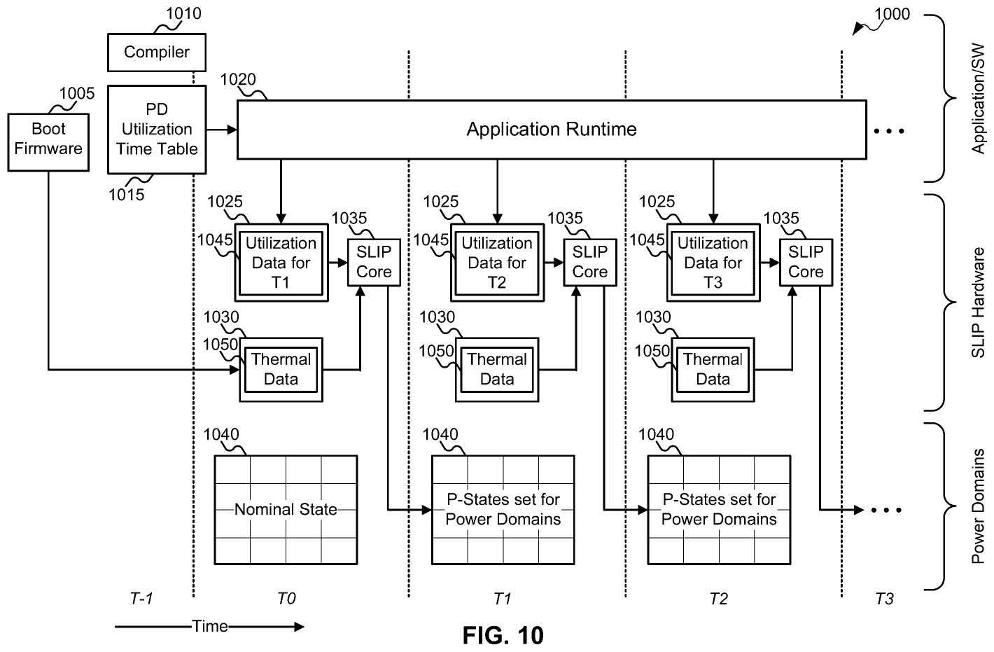

FIG. 10 depicts a schematic time diagram 1000 illustrating an example power steering process associated with the disclosed systems, in accordance with example embodiments of the disclosure. In some configurations, the schematic time diagram 1000 may be implemented by an example SLIP circuit (e.g., the SLIP circuit 135 of FIG. 1, the SLIP circuit 230 of FIG. 2, and/or the SLIP circuit 405 of FIG. 4). In some configurations, the schematic time diagram 1000 may be implemented in conjunction with machine 105, components of machine 105, or any combination thereof. The schematic time diagram 1000 is just one implementation and one or more operations of the schematic time diagram 1000 may be rearranged, reordered, omitted, and/or otherwise modified such that other implementations are possible and contemplated.

In the illustrated example, the schematic time diagram 1000 includes boot firmware 1005, a compiler 1010, a power domain utilization time table 1015, an application runtime 1020, a SLIP memory 1025, a configuration space 1030, a SLIP core 1035, and one or more power domains 1040. The SLIP memory 1025 stores utilization data 1045. The configuration space 1030 stores thermal data 1050. The SLIP memory 1025 may be an example of the memory 440 (e.g., SLIP memory) of the SLIP circuit 405. The configuration space 1030 may be an example of the configuration space 450 of the SLIP circuit 405. The utilization data 1045 may be an example of the utilization data 455 stored in the memory 440. The thermal data 1050 may be an example of the thermal data 460 stored in the configuration space 450. The SLIP core 1035 may be an example of the SLIP core 435 of the SLIP circuit 405. The one or more power domains 1040 may be an example of one or more power domains of the SLIP circuit 405 (e.g., power domain of the NOC 420, power domain of the memory controller 425, and/or power domain of the big core 470, etc.)

In one or more examples, the boot firmware 1005 includes a thermal distribution profile stored as a firmware configuration. The application runtime 1020 may be an application runtime of an example SLIP circuit (e.g., SLIP circuit 135 of FIG. 1, SLIP circuit 230 of FIG. 2, and/or SLIP circuit 405 of FIG. 4). As shown, the schematic time diagram 1000 depicts application/software of the example SLIP circuit, SLIP hardware of the example SLIP circuit, and power domains of the example SLIP circuit. In the illustrated example, the application/software of the example SLIP circuit includes the boot firmware 1005, the compiler 1010, the power domain utilization time table 1015. The SLIP hardware includes SLIP memory 1025 storing the utilization data 1045, configuration space 1030 storing the thermal data 1050, and the SLIP core 1035. The power domains of the example SLIP circuit include the one or more power domains 1040.

In implementations, the power domain utilization time table 1015 indicates scheduling data (e.g., start time, stop time, and/or length of time) for one or more time periods (e.g., time period T-1, time period TO, time period T1, time period T2, time period T3, and so on).

During time period T-1 (e.g., boot time), the boot firmware 1005 may be loaded into thermal data 1050. During time period T-1 and/or during time period TO, the compiler 1010 may generate and/or update the utilization data 1045. In some cases, the compiler 1010 may provide the utilization data 1045 to the application runtime 1020 (e.g., during time period T-1, during time period TO, and/or during another time period).

During time period TO, the application runtime 1020 may provide the utilization data 1045 for time period T1 to SLIP memory 1025. During time period TO, the SLIP memory 1025 may provide the utilization data 1045 for time period T1 to the SLIP core 1035. During time period TO, the configuration space 1030 may provide the thermal data 1050 to the SLIP core 1035. During time period TO, the SLIP core 1035 may set the power state of the one or more power domains 1040 to respective nominal states (e.g., a default power level applied to each given power domain). During time period TO, the SLIP core 1035 may compute for time period T1 (e.g., based on the thermal data 1050 and the utilization data 1045 for T1 provided by the application runtime during time period TO) a power state for each of the one or more power domains 1040. For example, during time period TO, the SLIP core 1035 may compute and implement a predictive dynamic voltage and frequency scaling (DVFS) policy for time period T1 based on the utilization data 1045 for T1 and the thermal data 1050 provided at time period TO.

During time period T1, the application runtime 1020 may provide the utilization data 1045 for time period T2 to SLIP memory 1025. During time period T1, the SLIP memory 1025 may provide the utilization data 1045 for time period T2 to the SLIP core 1035. During time period T1, the configuration space 1030 may provide the thermal data 1050 to the SLIP core 1035. During time period T, the SLIP core 1035 may apply each power state computed during time period TO to the respective one or more power domains 1040. During time period T1, the SLIP core 1035 may compute for time period T2 (e.g., based on the thermal data 1050 and the utilization data 1045 for T2 provided by the application runtime during time period T1). For example, during time period T1, the SLIP core 1035 may compute and implement a predictive DVFS policy for time period T2 based on the utilization data 1045 for T2 and the thermal data 1050 provided at time period T1.

During time period T2, the application runtime 1020 may provide the utilization data 1045 for time period T3 to SLIP memory 1025. During time period T2, the SLIP memory 1025 may provide the utilization data 1045 for time period T3 to the SLIP core 1035. During time period T2, the configuration space 1030 may provide the thermal data 1050 to the SLIP core 1035. During time period T2, the SLIP core 1035 may apply each power state computed during time period T1 to the respective one or more power domains 1040. During time period T2, the SLIP core 1035 may compute for time period T3 (e.g., based on the thermal data 1050 and the utilization data 1045 for T3 provided by the application runtime during time period T2). For example, during time period T2, the SLIP core 1035 may compute and implement a predictive DVFS policy for time period T3 based on the utilization data 1045 for T3 and the thermal data 1050 provided at time period T2.

Accordingly, for each give time period the SLIP core 1035 may receive from SLIP memory 1025 utilization data 1045 for a subsequent time period and receive from configuration space 1030 thermal data 1050 provided at least during a boot time. The SLIP core 1035 may then compute and implement a predictive DVFS policy for the subsequent time period based on the utilization data 1045 and the thermal data 1050. In some cases, the thermal data 1050 may be updated during any given time period (e.g., during time period T1). Accordingly, the SLIP core 1035 may compute predictive power states based at least in part on updated thermal data.

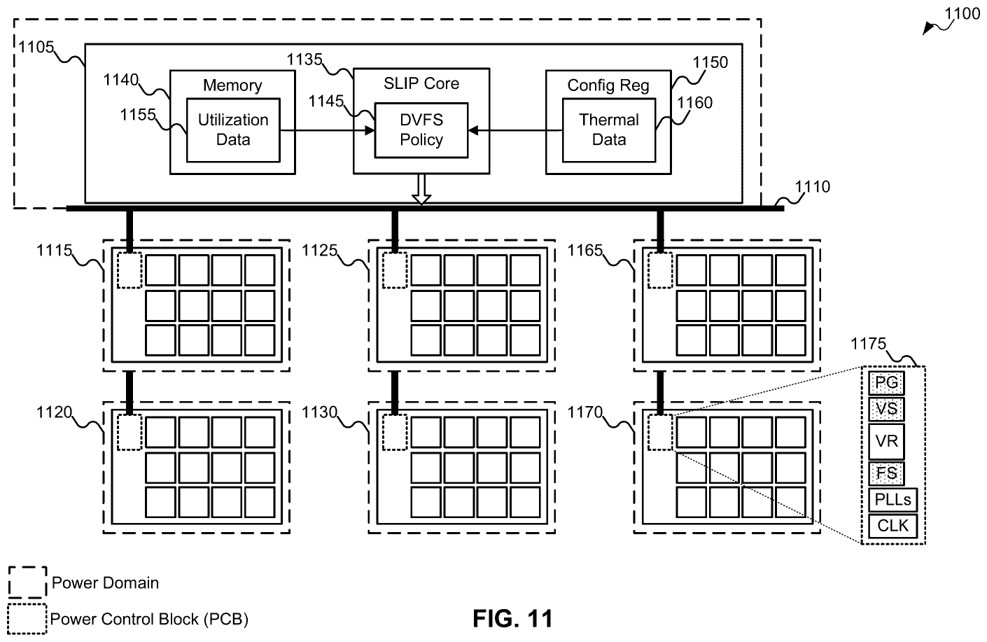

FIG. 11 shows an example schematic diagram of a self-learning intelligent power-drive (SLIP) circuit that can be used in association with a system (e.g., system on chip), according to embodiments of the disclosure.

In the illustrated example, FIG. 11 depicts a system on chip (SOC) 1100. The SOC 1100 may be an example of the SOC 400 of FIG. 4. As shown, the SOC 1100 includes a SLIP circuit 1105, a power control bus 1110, and one or more power domains. The one or more power domains may include power domain 1115, power domain 1120, power domain 1125, power domain 1130, power domain 1165, and/or power domain 1170. In some examples, the power control bus 1110 is a low-latency power control bus that improves communication between the SLIP circuit 1105 and the individual power domains of the SOC 1100.

In the illustrated example, the SLIP circuit 1105 includes a SLIP core 1135 (e.g., one or more SLIP cores that include at least SLIP core 1135), memory 1140 (e.g., a static random-access memory, SLIP memory, one or more SLIP memories), and a configuration register 1150. The SLIP core 1135 may include a predictor or a prediction unit, which may be an example of predictor 445 of FIG. 4. The configuration register 1150 may include a configuration space, which may be an example of the configuration space 450 of FIG. 4. The SLIP circuit 1105 and components thereof (e.g., SLIP core 1135, memory 1140, and/or configuration register 1150) include any combination of hardware, logical circuitry, firmware, and/or software to perform predictive power steering in a given system (e.g., SOC 1100).

As shown, the memory 1140 includes utilization data 1155. In one or more examples, the configuration register 1150 includes thermal data 1160. In one or more examples, the SLIP circuit 1105 includes a hardware block of the SOC 1100 that is configured to steer power across one or more components of the SOC 1100 by proactively setting power states (e.g., P-states) for individual power domains of the SOC 1100. Thus, the SLIP circuit 1105 maximizes performance of the SOC 1100 for a given power envelope. The SLIP circuit 1105 prevents thermal runaway based on positional and spatial thermal properties of regions of the SOC 1100.

In the illustrated example, the power domains of the SOC 1100 include at least the SLIP circuit 1105, power domain 1115, power domain 1120, power domain 1125, power domain 1130, power domain 1165, and/or power domain 1170. As shown, the depicted power domains power domain 1115, power domain 1120, power domain 1125, power domain 1130, power domain 1165, and/or power domain 1170 may include one or more components (e.g., processing cores, core neighborhoods, etc.).

In the illustrated example, one or more components of the SOC 1100 include a power control block. In the illustrated example, the power domain 1170 includes power control block 1175. Additionally, or alternatively, power domain 1115, power domain 1120, power domain 1125, power domain 1130, and/or power domain 1165 include a power control block. As shown, the power control block of each power domain is connected to the power control bus 1110. The power control block 1175 may include at least one of power gating (PG), voltage scaler (VS), a voltage regulator (VR), frequency scaler (FS), one or more phase-locked loops (PLLs), and/or a clock (CLK). In some cases, the control components of the power control block 1175 include the at least one of the power gating, the voltage scaler, and/or the frequency scaler. In one or more examples, each power control block of the SOC 1100 includes at least one of power gating, voltage scaler, a voltage regulator, frequency scaler, one or more phase-locked loops, and/or a clock.

In one or more examples, the utilization data 1155 is generated during a compile time associated with the SOC 1100 (e.g., a compile time the SOC 1100). In variations, the utilization data 1155 is loaded into the memory 1140 during a runtime associated with the SOC 1100 (e.g., during a runtime of the SOC 1100, during runtime of an application, runtime of an operating system, runtime of a firmware configuration, after a boot time of SOC 1100, etc.). In some cases, the utilization data 1155 includes an application runtime that provides the SLIP circuit 1105 a list of resources (e.g., core-neighborhoods) to be utilized (e.g., expected to be utilized) in a next time slice (e.g., time period T-1, time period TO, time period T1, time period T2, time period T3, of FIG. 10). The utilization data may be provided to the SLIP circuit 1105 as a binary table of power domains that will be utilized (e.g., in a next time slice). Additionally, or alternatively, the SLIP core 1135 may convert (e.g., compute) the utilization data into a binary table of power domains that will be utilized (e.g., in a next time slice).

Additionally, or alternatively, the utilization data 1155 includes an application runtime that provides SLIP circuit 1105 expected resources to be utilized (e.g., expected to be utilized) in a next time slice. In some cases, the utilization data may be provided to the SLIP circuit 1105 as an average activity factor for the various power domains. Additionally, or alternatively, the SLIP core 1135 may convert (e.g., compute) the utilization data into an average activity factor for the various power domains.

Additionally, or alternatively, the utilization data 1155 includes an application runtime that provides SLIP circuit 1105 an expected activity factor for various power domains based on the resources to be used. In some cases, the utilization data may be provided to the SLIP circuit 1105 as an average activity factor for various power domains based on the resources that would be used. Additionally, or alternatively, the SLIP core 1135 may convert (e.g., compute) the utilization data into an average activity factor for various power domains based on the resources that would be used.

The thermal data 1160 may be provided during boot-time and based on thermal modeling and analysis. The thermal data 1160 may be based on and/or include data from a table of positional data, spatial data, and/or TDP limits of one or more power domains (e.g., Table 1, thermal data of each power domain of SOC 1100). In some cases, the thermal data 1160 may include capacitance data of a power domain, area of a power domain, one or more thermal properties of a power domain (e.g., thermal conductivity).

In the illustrated example, the SLIP core 1135 (e.g., in conjunction with a prediction unit such as predictor 445), may analyze the utilization data 1155 and the thermal data 1160 and predict an expected power for at least one power domain based on the analysis. With reference to FIG. 10, the SLIP core 1035 may compute and implement a predictive dynamic voltage and frequency scaling (DVFS) policy 1145 for a time period T1 based on utilization data 1155 for T1 and thermal data 1160 provided at time period TO. In some cases, the SLIP core 1135 steers the predicted power based on expected power (e.g., maintaining, increasing, decreasing power) to a power control block of a given power domain (e.g., power control block 1175). In some cases, the SLIP core 1135 calculates expected power for one or more power domains using utilization data 1155 (e.g., activity factor information provided by runtime, provided by a runtime application) and thermal data 1160 (e.g., thermal property information obtained during boot-time). Accordingly, the utilization data 1155 and the thermal data 1160 may be used by the SLIP circuit 1105 to maintain thermal limits of one or more power domains. Thus, the SLIP circuit 1105 predictively prevents thermal run-away of the SOC 1100.

In the embodiments described herein, the configurations and operations are example configurations and operations, and may involve various additional configurations and operations not explicitly illustrated. In some embodiments, some of the illustrated configuration and/or operation may be omitted. In some embodiments, one or more of the operations may be performed by components other than those illustrated herein. Additionally, in some embodiments, the temporal order of the operations may be varied.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBec™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
obtaining a first data of a power domain of a system on chip and a second data of the power domain;
predicting an expected power for the power domain based on the first data and the second data; and
applying to the power domain a power level that is selected based on the expected power.

2. The method of claim 1, wherein:
the first data is utilization data and the second data is thermal data, and
the thermal data comprises at least one of a spatial thermal limit of the power domain or a positional thermal limit of the power domain.

3. The method of claim 2, wherein the spatial thermal limit of the power domain is based on at least one of:
an area of the power domain;
a proximity of the power domain to a component of the system on chip that is outside the power domain; or
a power level of the component at a time when the expected power is calculated.

4. The method of claim 2, wherein the positional thermal limit of the power domain is based on a location of the power domain on the system on chip.

5. The method of claim 2, wherein at least one of the spatial thermal limit or the positional thermal limit of the power domain is based on thermal modeling data obtained from a simulation of the power domain operating at one or more power levels.

6. The method of claim 1, wherein:
the expected power is calculated before a first time period, and
the power level is applied during the first time period.

7. The method of claim 2, further comprising predicting an updated expected power for the power domain for a second time period based on at least one of an updated utilization data or an updated thermal data.

8. The method of claim 7, further comprising applying to the power domain a second power level selected based on the updated expected power, wherein the updated expected power is calculated before or during the second time period, and the second power level is applied during the second time period.

9. The method of claim 2, wherein the utilization data of the power domain is based on a capacitance associated with the power domain and an activity factor of the power domain, the activity factor indicating an activity level of the power domain.

10. The method of claim 1, wherein prediction of the expected power is based on implementing a machine learning model that is trained on power utilization training data from at least one of a system of the power domain, a test system of the power domain, or a simulated system of the power domain.

11. The method of claim 2, further comprising:
generating the utilization data of the power domain; and
loading the utilization data of the power domain into a memory of the system on chip.

12. The method of claim 2, wherein the thermal data is obtained during a boot time of the system on chip.

13. A device, comprising:
a memory to obtain first data of a power domain of the device;
a configuration space to obtain second data of the power domain;
a prediction unit to predict an expected power for the power domain based on the first data and the second data; and
a self-learning intelligent power-drive circuit to apply to the power domain a power level that is selected based on the expected power.

14. The device of claim 13, wherein:
the first data is utilization data and the second data is thermal data, and
the thermal data comprises at least one of a spatial thermal limit of the power domain or a positional thermal limit of the power domain.

15. The device of claim 14, wherein the spatial thermal limit of the power domain is based on at least one of:
an area of the power domain;
a proximity of the power domain to a component of the device that is outside the power domain; or
a power level of the component at a time when the expected power is calculated.

16. The device of claim 14, wherein the positional thermal limit of the power domain is based on a location of the power domain on the device.

17. The device of claim 14, wherein at least one of the spatial thermal limit or the positional thermal limit of the power domain is based on thermal modeling data obtained from a simulation of the power domain operating at one or more power levels.

18. A system, comprising:
at least one memory; and
at least one processor coupled with the at least one memory configured to cause the system to:
obtain first data of a power domain of the system and second data of the power domain;
predict an expected power for the power domain based on the first data and the second data; and
apply to the power domain a power level that is selected based on the expected power.

19. The system of claim 18, wherein:
the first data is utilization data and the second data is thermal data, and
the thermal data comprises at least one of a spatial thermal limit of the power domain or a positional thermal limit of the power domain.

20. The system of claim 19, wherein:
the spatial thermal limit of the power domain is based on at least one of an area of the power domain, a proximity of the power domain to a component of the system on chip that is outside the power domain, or a power level of the component at a time when the expected power is calculated; and
the positional thermal limit of the power domain is based on a location of the power domain on the system on chip.
